(19) United States
(12) Patent Application Publication
(10) Pub. No.: US 2010/0204922 A1
(43) Pub. Date: Aug. 12, 2010

(54) METHOD AND APPARATUS FOR SELECTING PHARMACOGENOMIC MARKERS

(75) Inventors: Tae-jin AHN, Seoul (KR); Kyu-sang LEE, Suwon-si (KR); Dae-soon SON, Seoul (KR); Kyung-hee PARK, Seoul (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/623,675

(22) Filed: Nov. 23, 2009

(30) Foreign Application Priority Data
Feb. 10, 2009 (KR) 10-2009-0010623

(51) Int. Cl. G06F 19/00; G06F 17/18

(52) U.S. Cl. 702/19; 702/181

(57) ABSTRACT

Provided are a method and apparatus for selecting pharmacogenomic markers. The method includes calculating evaluation indexes for evaluating the degree of association between genetic markers of genes associated with at least one drug and the drug, and selecting some of the genetic markers based on the calculated evaluation indexes.

### CROSS-REFERENCE TO RELATED APPLICATIONS

This application claims priority to Korean Patent Application No. 10-2009-0010623, filed on Feb. 10, 2009, and all the benefits accruing therefrom under 35 U.S.C. §119, the content of which in its entirety is herein incorporated by reference.

### BACKGROUND

1. Field

One or more embodiments relate to a method and apparatus for selecting pharmacogenomic markers.

2. Description of the Related Art

The genome of a living organism refers to all the genetic information of the living organism. Although many technologies for analyzing the genome of an individual are under development, none have yet been commercialized except for only genome analysis devices, such as a deoxyribonucleic acid (DNA) chip. Research on personalized medicine through cooperation between DNA chip manufacturers and genome analysis service providers has been carried out.

### SUMMARY

Disclosed herein is an apparatus and method for selecting pharmacogenomic markers, which enable a genome analysis device to offer efficient and excellent performance by focusing on a particular drug. One or more embodiments include a computer-readable recording medium having embodied thereon a program for executing the method in a computer system.

Exemplary embodiments aspects will be set forth in part in the description which follows and, in part, will be apparent from the description.

According to one embodiment, a method of selecting pharmacogenomic markers, the method including: calculating evaluation indexes for evaluating the degree of association between genetic markers of genes associated with at least one drug and the drug; and selecting the genetic markers based on the calculated evaluation indexes in consideration of the number of SNPs that may be analyzed by the genome analysis device.

In one embodiment, a computer-readable recording medium having embodied thereon a program for executing a method of selecting pharmacogenomic markers, wherein the method includes: calculating evaluation indexes for evaluating the degree of association between genetic markers of genes associated with at least one drug and the drug; and selecting the genetic markers based on the calculated evaluation indexes in consideration of the number of SNPs that may be analyzed by the genome analysis device.

In another embodiment, an apparatus for selecting pharmacogenomic markers, the apparatus including: a calculating unit calculating the degree of association between genetic markers of genes associated with at least one drug and the drug; and a selecting unit selecting genetic markers based on the calculated evaluation indexes in consideration of the number of SNPs that may be analyzed by the genome analysis device.

In still another embodiment, a method for selecting pharmacogenetic markers associated with a compound, the method comprising selecting a compound, wherein the compound may be a drug, a gene, a protein, or other biomolecule; obtaining information about the compound; expanding gene nodes indicating genes biologically associated with the compound; calculating evaluation indexes demonstrating the degree of association between the compound and genetic markers of genes associated with the compound; selecting the genetic markers of the genes associated with the compound based on the evaluation indexes; outputs information about the selected genetic marker and optimal combinations of the genetic marker for use as pharmacogenetic markers associated with a compound.

In still another embodiment, an apparatus for selecting pharmacogenomic markers associate with a compound, the apparatus comprising, a communication unit; a data storage unit; a processing unit comprising a selecting unit, a calculating unit for calculating evaluation index indicating the degree of association between a compound and genetic markers of genes associated with the compound; and a selecting unit for selecting genetic markers based on the evaluation indexes determined by the calculating unit; and an output unit.

### BRIEF DESCRIPTION OF THE DRAWINGS

These and/or other aspects, advantages and features of the invention will become apparent by describing in further detail exemplary embodiments thereof with reference to the attached drawings, in which:

FIG. 1 is a block diagram of an exemplary embodiment of an apparatus for selecting pharmacogenomic markers;

FIG. 2 is a flowchart illustrating an exemplary embodiment of a method of selecting pharmacogenomic markers;

FIG. 3 shows a drug for which genome analysis using pharmacogenomic markers is required;

FIG. 4 is a flowchart illustrating an exemplary embodiment of operation 22 of the method of FIG. 2;

FIG. 5 is a diagram illustrating an exemplary embodiment of seed gene nodes generated by a data expanding unit of the apparatus of FIG. 1;

FIG. 6 is a diagram illustrating an exemplary embodiment of gene nodes primarily expanded from the seed gene nodes by the data expanding unit of the apparatus of FIG. 1;

FIG. 7 is a diagram illustrating an exemplary embodiment of gene nodes secondarily expanded from the seed gene nodes by the data expanding unit of the apparatus of FIG. 1;

FIG. 8 is a diagram illustrating an exemplary embodiment of gene nodes extracted by the data expanding unit of the apparatus of FIG. 1;

FIG. 9 is a table providing exemplary genetic marker information collected by the data expanding unit of the apparatus of FIG. 1;

FIG. 10 is a flowchart illustrating an exemplary embodiment of operation 23 of the method of FIG. 2;

FIG. 11 is a table including the coverage and the statistical power of genetic markers calculated by a calculating unit of the apparatus of FIG. 1; and

FIG. 12 is a flowchart illustrating an exemplary embodiment of operation 24 of the method of FIG. 2.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art.

It will be understood that when an element is referred to as being “on” or “connected to” another element, the element can be directly on or connected to another element or intervening elements. In contrast, when an element is referred to as being “directly on” or “directly connected to” another element, there are no intervening elements present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the disclosure.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Reference will now be made in detail to embodiments, examples of which are illustrated in the accompanying drawings. In one embodiment, an apparatus for selecting pharmacogenomic markers associate with a compound, the apparatus comprising, a communication unit; a data storage unit; a processing unit comprising a selecting unit: a calculating unit for calculating evaluation index indicating the degree of association between a compound and genetic markers of genes associated with the compound; and a selecting unit for selecting genetic markers based on the evaluation indexes determined by the calculating unit; and an output unit.

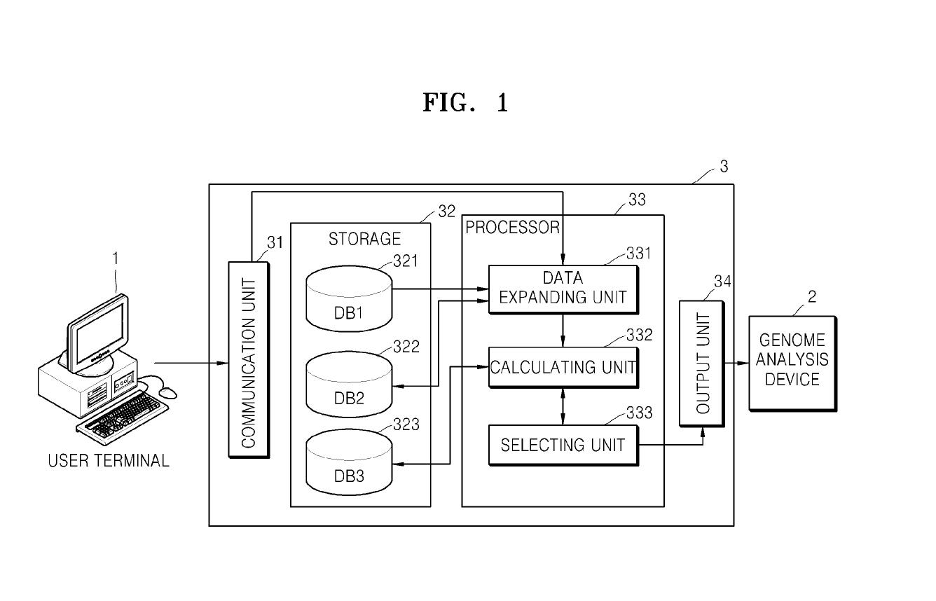

Reference will now be made in detail to embodiments of the apparatus for selecting pharmacogenomic markers, examples of which are illustrated in the accompanying drawings. FIG. 1 is a block diagram describing an exemplary embodiment of an apparatus 3 for selecting pharmacogenomic markers. Referring to FIG. 1, the apparatus 3 includes a communication unit 31, a storage unit 32, a processor unit 33, and an output unit 34. The communication unit 31 may be connected to a user terminal 1. The user terminal 1 is optionally connected to wide area data network, such as the Internet, or a wired/wireless local area network (LAN). The storage unit 32 includes a first database 321, a second database 322, and a third database 323. The processor unit 33 includes a data expanding unit 331, a calculating unit 332, and a selecting unit 333. The processor unit 33 including the data expanding unit 331, the calculating unit 332, and the selecting unit 333 may be an array of logic gates, or a combination of a general-purpose microprocessor and a memory storing a program that is executed by the general-purpose microprocessor. The present embodiment is not limited thereto, and the processor unit 33 may be other types of hardware.

In one embodiment, the output unit is an interface for direct user interface, such as the user terminal described in FIG. 1. In another embodiment the output unit is connected to a connected to wide area data network, such as the Internet, or a wired/wireless local area network (LAN). The output unit may also be connected to the genome analysis unit.

Referring still to FIG. 1, apparatus 3 may be further connected to a genome analysis device 2. In one embodiment, the genome analysis device 2 is used for analyzing the genome of an individual in order to examine the genetic safety of a drug. The genome analysis device may be manufactured for analysis of a compound, wherein the compound may be a drug, a gene, a protein, or other biomolecule. The genome analysis device may be manufactured for analysis of a single drug or multiple drugs.

The genome analysis device may be manufacture for analysis of a single drug or multiple drugs. For instance, if a user wants to analyze a genome associated with a particular drug, the user may contact a genome analysis device manufacturer and order the production a genome analysis device for analyzing the genome directed to that drug. A genome analysis device for analyzing the genome directed to that drug may include genes known to be, and genes which are thought to be, associated with the particular drug. In order to manufacture the genome analysis device, the manufacturer needs information about the particular drug. Accordingly, the user provides information known about the particular drug to the genome analysis device manufacturer required for making the genome analysis device. Useful information for making the genome analysis device includes, for example, known drug-gene relationship, known drug-protein interactions, and any other information known about the metabolism, delivery or toxicity of the drug associated to be evaluated. Once the manufacturer has the information known about the particular drug, the manufacturer can then manufacture the genome analysis device 2 according to known methods.

In order to prevent the characteristics of the present embodiment from being obscured, only hardware components related to the present embodiment will now be explained. However, it is to be understood by one of ordinary skill in the art that general-purpose hardware components other than the hardware components illustrated in FIG. 1 may be included in the apparatus 3.

In one embodiment, a method for selecting pharmacogenetic markers associated with a compound, the method comprising selecting a compound, wherein the compound may be a drug, a gene, a protein, or other biomolecule; obtaining information about the compound; expanding gene nodes indicating genes biologically associated with the compound; calculating evaluation indexes demonstrating the degree of association between the compound and genetic markers of genes associated with the compound; selecting the genetic markers of the genes associated with the compound based on the evaluation indexes; outputs information about the selected genetic marker and optimal combinations of the genetic marker for use as pharmacogenetic markers associated with a compound.

In one embodiment, the method of selecting pharmacogenetic markers provide information related to the genetic safety of a compound is used in the design of genome analysis device for evaluating a compound, wherein the compound may be a drug, a gene, a protein, a biomolecule, or combinations thereof. The genome analysis device may be manufactured for analysis of a single drug or multiple drugs. For instance, if a user wants to analyze a genome associated with a particular drug, the user may contact a genome analysis device manufacturer and order the production a genome analysis device for analyzing the genome directed to that drug. A genome analysis device for analyzing the genome directed to that drug may include genes known to be, and genes which are thought to be, associated with the particular drug. In order to manufacture the genome analysis device, the manufacturer needs information about the particular drug such as, pharmacokinetic markers associated with the drug. Accordingly, the user provides information known about the particular drug to the genome analysis device manufacturer required for making the genome analysis device. Useful information for making the genome analysis device includes, for example, known drug-gene relationship, known drug-protein interactions, and any other information known about the metabolism, delivery or toxicity of the drug associated to be evaluated. Once the manufacturer has the information known about the particular drug, the manufacturer can then manufacture the genome analysis device 2 according to known methods. An exemplary genome analysis device may analyse the genome of an individual using blood or saliva from the individual, in order to examine the genetic safety of a compound. Examples of the genome analysis device 2 include, for example, a deoxyribonucleic acid (DNA) chip, a genome analysis device using DNA sequencing, a genome analysis device using polymerase chain reaction (PCR), and a genome analysis device using antibodies.

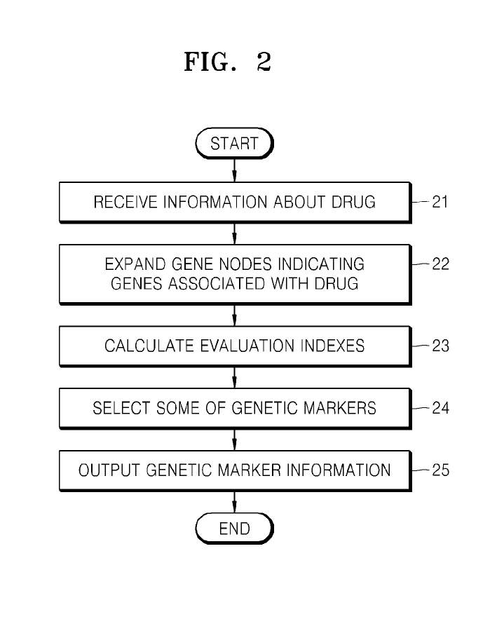

FIG. 2 is a flowchart illustrating an exemplary embodiment of a method of selecting pharmacogenomic markers. The flowchart of FIG. 2 makes reference to a drug. However, the method may be adapted to selecting pharmacogenetic markers associated a compound, wherein the compound may be a drug, a gene, a protein, or other biomolecule. Referring to FIG. 2, the method includes operations sequentially processed by the apparatus 3 of FIG. 1. The operations of the hardware components of the apparatus 3 of FIG. 1 will now be explained with reference to the flowchart of FIG. 2.

In operation 21, the communication unit 31 receives information about at least one drug from a user terminal 1 through direct user input, a wide area network, such as the Internet, or a wired/wireless local area network (LAN). In general, the communication unit 31 may be a network card such as an Ethernet card.

In operation 22, the data expanding unit 331 expands gene nodes indicating genes biologically associated with the drug, information about which is received by the communication unit 31 in operation 21. As used herein, a “gene node” is a node indicating one gene. Also, a gene node may indicate a protein or other substance. Also, a gene node may indicate a gene, a protein, or other substance associated with a drug target, metabolism, delivery, and toxicity of the drug.

In operation 23, the calculating unit 332 calculates evaluation indexes for evaluating the degree of association between the drug and the genetic markers of the genes corresponding to the gene nodes expanded by the data expanding unit 331 in operation 22. In an exemplary embodiment, the evaluation indexes include a coverage, which is a probability that the genetic markers could cover all variations of the genes associated with the drug, and a statistical power, which is a probability that the genetic markers could determine true genetic variations of the genes associated with the drug.

In operation 24, the selecting unit 333 selects some of the genetic markers of the genes corresponding to the gene nodes, which are expanded by the data expanding unit 331, based on the evaluation indexes calculated by the calculating unit 332 in operation 23. The evaluation indexes include a coverage and statistical power.

In operation 25, the output unit 34 outputs genetic marker information of the genetic markers of the optimal combinations, which are selected in operation 24, directly to the user. Optionally, in operation 25, the output unit 34 outputs genetic marker information of the genetic markers of the optimal combinations, which are selected in operation 24 to the genome analysis device 2 or to a server of the genome analysis device manufacturer. The genetic marker information of the genetic markers of the optimal combinations selected in operation 24 may be provided to the genome analysis device manufacturer, and the genome analysis device manufacturer can then manufacture a genome analysis device 2, e.g., a DNA chip, reflecting the genetic markers of the optimal combinations selected in operation 24. Further, the genetic marker information of the genetic markers of the optimal combinations selected in operation 24 may be directly input to the genome analysis device 2 to be used by the genome analysis device 2.

In the present embodiment, genetic markers of optimal combinations for one drug may be selected, or genetic markers of optimal combinations for a plurality of drugs may be selected. The genetic markers of the optimal combinations for one drug may be used for personalized prescription of a single drug, and the genetic markers of the optimal combinations for the plurality of drugs may be used for combination therapy of a drug group. Examples of the drug group may include drugs considered to be administered to a particular individual, drugs related to a particular disease, and pipeline drugs of a particular pharmaceutical company.

Although a method of selecting genetic markers with respect to one drug will be explained herein below, a method of selecting genetic markers with respect to a plurality of drugs, or other compounds as defined above, can be easily understood by one of ordinary skill in the art from the following description. Hereinafter, explanation of the present embodiment will be made on the basis that the drug is Warfarin. Warfarin is an anticoagulant, which acts by inhibiting vitamin K-dependent coagulation factors. Certain single nucleotide polymorphisms in the vitamin K epoxide reductase (VKORC1) gene, especially the −1639G>A allele, have been associated with lower dose requirements for Warfarin. About 55% of the variability in warfarin dose could be explained by the combination of VKORC1 and CYP2C9 genotypes, age, height, body weight, interacting drugs, and indication for warfarin therapy in Caucasian patients. Similar observations have been reported in Asian patients. In view of this information, the FDA recommends that a test on pharmacogenomic markers be made for Warfarin. In one embodiment, in order to perform a test on pharmacogenomic markers associated with Warfarin, the user inputs information about Warfarin into the user terminal 1.

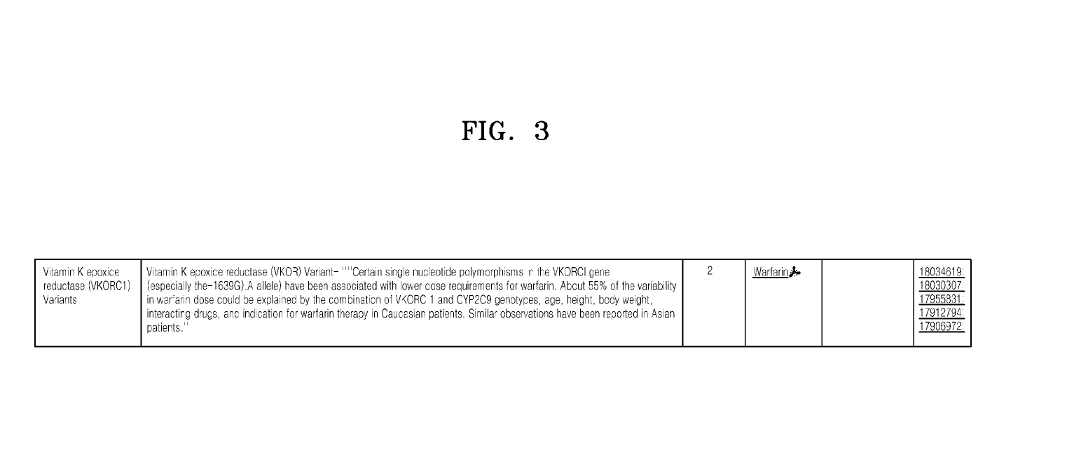

FIG. 3 shows a drug for which genome analysis using pharmacogenomic markers is required. In particular, FIG. 3 shows a federal drug administration (FDA) drug label of Warfarin, which is a type of anticoagulant. With regard to the FDA drug label of FIG. 3, column 3, reference numeral “1” signifies that a test on biomarkers, that is, pharmacogenomic markers, of a drug is required, reference numeral “2” signifies that a test is recommended, and reference numeral “3” signifies that only information about the drug is necessary without any test. Referring to FIG. 3, column 3, since reference numeral “2” is written, a test on the pharmacogenomic markers of Warfarin is recommended. In order to perform a test, the user inputs information about Warfarin into the user terminal 1. The following explanation will be made on the basis that the drug is Warfarin.

As noted above, in operation 22 of FIG. 2, in operation 22, the data expanding unit 331 expands gene nodes indicating genes biologically associated with the drug, information about which is received by the communication unit 31 in operation 21. Although one gene node indicates one gene in the present embodiment, one gene node may indicate a protein or other substance. The gene node may be assigned an identifier such as a name of a gene, a protein, or another substance. In particular, each of the gene nodes indicating the genes biologically associated with the drug in the present embodiment indicates a gene, a protein, or other substance associated with a drug target, metabolism, delivery, and toxicity of the drug.

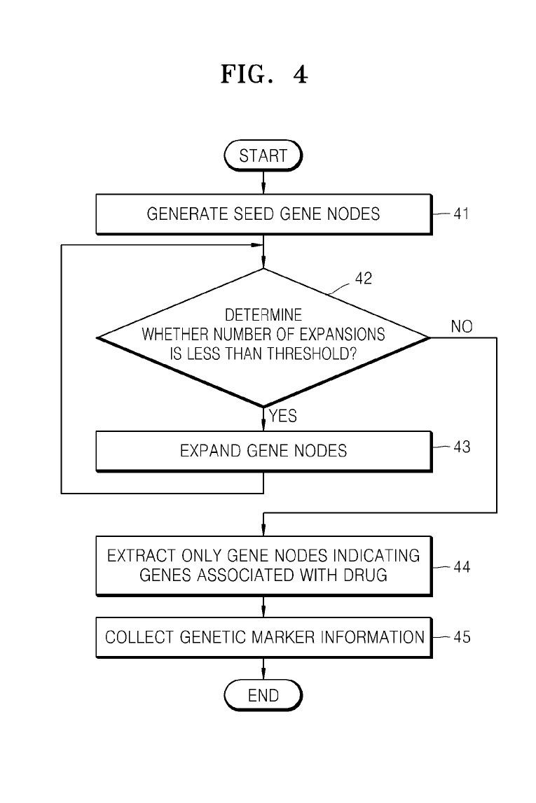

FIG. 4 is a flowchart illustrating an exemplary embodiment of operation 22 of the method of FIG. 2. Referring to FIG. 4, operation 22 includes the following operations sequentially processed by the data expanding unit 331 of the apparatus 3 of FIG. 1. The operation of the data expanding unit 331 of the apparatus 3 of FIG. 1, according to an embodiment, will now be explained in detail with reference to the flowchart of FIG. 4.

Referring to FIG. 4, in operation 41, the data expanding unit 331 generates seed gene nodes by identifying genes biologically primarily associated with the drug using the information received by the communication unit 31, with reference to the first database 321 of the storage unit 32. The information received by the communication unit includes a list of genes that have interaction with queried drug. Such information is previously collected and stored in database 321. The seed gene nodes are generated by evaluating and comparing known drug-gene interactions. The first database 321 is a database recording a list of seed genes biologically primarily associated with various drugs. However, the seed gene nodes are not limited to identifying only the seed genes biologically primarily associated with the drug. The seed gene nodes may also identify protein or any other substances primarily associated with a drug target, metabolism, delivery, and toxicity of the drug. Thus, the seed gene nodes are generated by evaluating and comparing known drug-gene interactions, known drug-protein interactions, and any other information known about the metabolism, delivery or toxicity of the drug. For ease of discussion, when referring to gene nodes, a gene, protein, and another substance will not be distinguished and will be simply referred to as a gene.

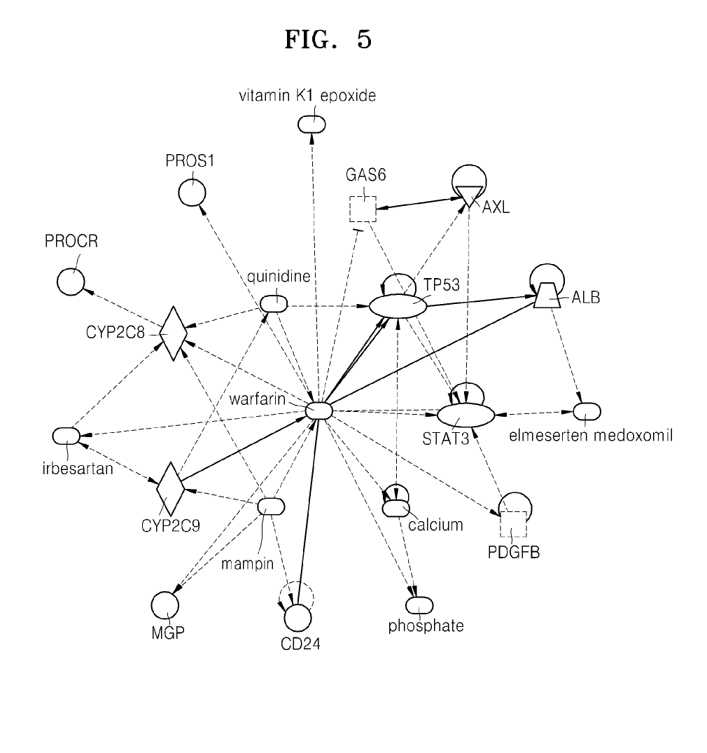

FIG. 5 is a diagram illustrating the seed gene nodes generated by the data expanding unit 331 of the apparatus 3 of FIG. 1 for the drug warfarin. The seed gene nodes illustrated in FIG. 5 are generated by known drug-gene relationship, known drug-protein interactions, and any other information known about the metabolism, delivery or toxicity of the drug. In this illustration, Warfarin related genes are demonstrated by using a commercially available pathway displaying software, Ingenuity Pathway Analysis (IPA), available from Ingenuity Systems. In FIG. 5, the gene nodes identified using capital letters represent genes, and the gene nodes identified using small letters represent proteins or other substances. In FIG. 5, the lines connecting the gene, protein, or other substance to Warfarin represent a biological relationship with Warfarin. In particular, solid lines indicate that the biological relationship is disclosed in certain publications or other documentation, and dotted lines indicate that the biological relationship is demonstrated through software for biological relationship analysis, such as the IPA.

Referring again to FIG. 4, in operation 42, the data expanding unit 331 determines whether the number of expansions of the gene nodes biologically associated with the drug from the seed gene nodes, which are generated in operation 41 is less than a threshold. A single expansion identifies genes that are biologically primarily associated with the drug, that is genes having a known drug-gene interaction, known drug-protein interactions, and any other information known about the metabolism, delivery or toxicity of the drug is disclosed in certain publications or other documentation, or has been demonstrated through software for biological relationship analysis. Once the data expanding unit 331 has identified genes that are primarily associated with the drug, if the number of expansions is less than a threshold, additional expansions may be conducted to identify genes that are biologically secondarily associated with the drug. In order to identify genes that are biologically secondarily associated with the drug. Thus, a second, or third, etc. expansion identifies genes having a known interaction with a gene identified in the first expansion. If it is determined in operation 42 that the number of expansions is less than the threshold, the method proceeds to operation 43, and otherwise, the method proceeds to operation 44. When the method proceeds to operation 43, additional expansions are conducted until the threshold is reached. The threshold is the number of expansions desired by the user or a designer of the apparatus 3. The threshold may be determined by the designer of the apparatus 3 in consideration of hardware specifications of the apparatus 3, or may be determined by the user in consideration of how much the user wants a genome analysis service. As the threshold increases, precision in selecting the pharmacogenomic markers increases but the amount of data to be processed by the apparatus 3 increases greatly. If the threshold is 0, the method proceeds to operation 44 without expanding the gene nodes.

Referring still to FIG. 4, in operation 43, the data expanding unit 331 expands the gene nodes biologically associated with the drug from the seed gene nodes, which are generated in operation 41, with reference to the second database 322 of the storage unit 32. The second database 322 is a database recording a list of genes biologically primarily associated with various genes. Accordingly, the gene nodes expanded from the seed gene nodes are biologically secondarily associated with the drug.

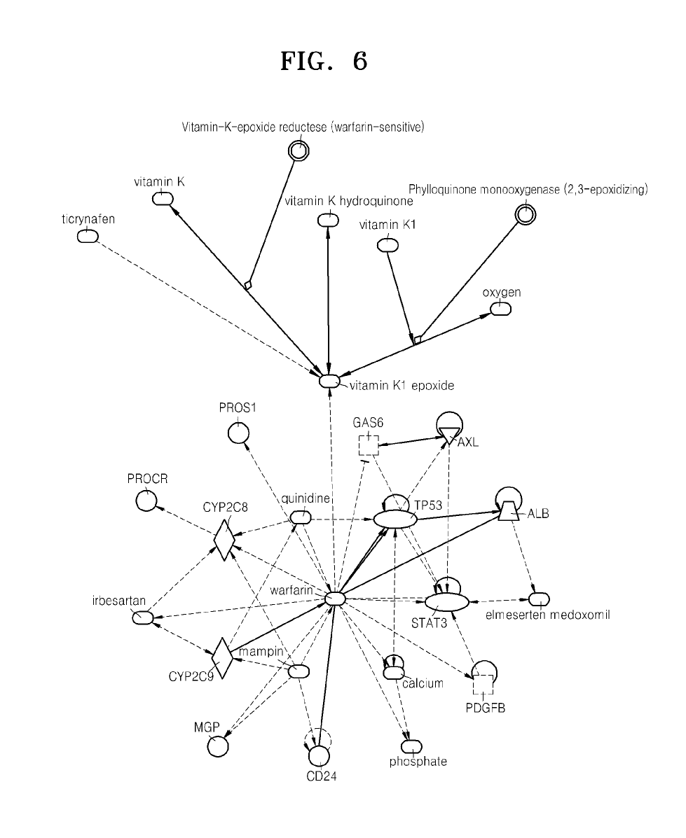

FIG. 6 is a diagram illustrating the gene nodes primarily expanded from the seed gene nodes by the data expanding unit 331 and data expanding unit 332 of the apparatus 3 of FIG. 1. In particular, the gene nodes illustrated in FIG. 6 are the seed gene nodes of FIG. 5 and gene nodes expanded from a gene node “vitamin k1 epoxide.”

If the expansions of the gene nodes by the data expanding unit 331 are completed in operation 43, the method returns to operation 42. If the threshold is 2, since the gene nodes are expanded once in operation 43, the data expanding unit 331 compares the number (1) of expansions with the threshold in operation 42, and the method proceeds to operation 43. In operation 43, the data expanding unit 331 generates gene nodes expanded from the gene nodes expanded from the seed gene nodes with reference to the second database 322 of the storage unit 32. Next, in operation 42, the data expanding unit 331 determines whether the number of expansions of the gene nodes is less than the threshold. Since the number of expansions in operation 43 is 2 and thus is not less than the threshold, the method proceeds to operation 44. In such a way, the gene nodes are repeatedly expanded in operations 42-43 until the number of expansions reaches the threshold.

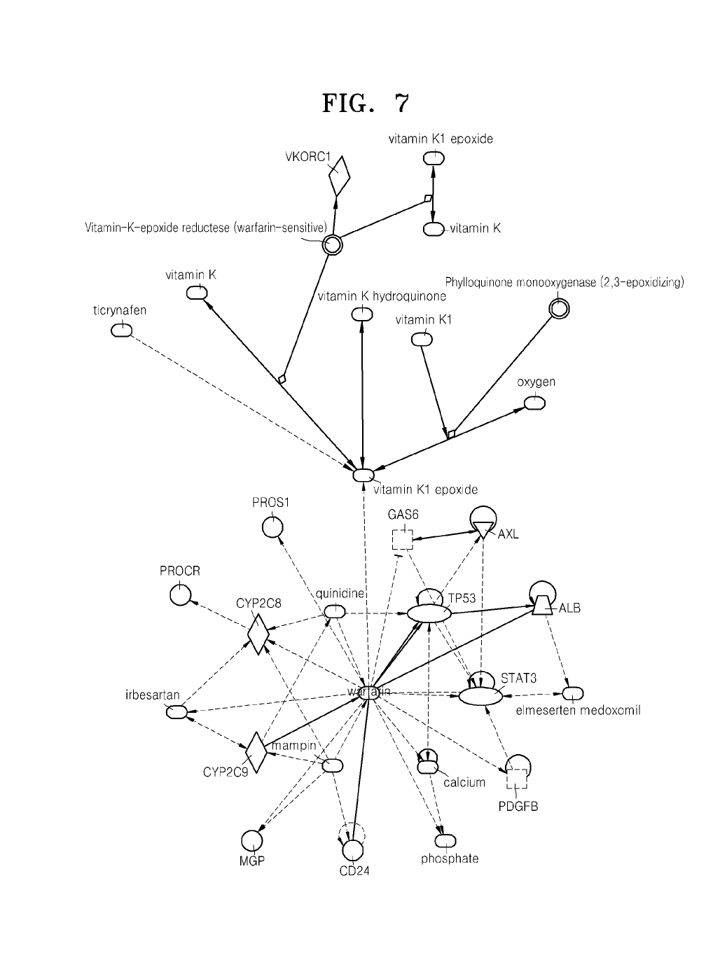

FIG. 7 is a diagram illustrating the gene nodes secondarily expanded from the seed gene nodes by the data expanding unit 331 of the apparatus 3 of FIG. 1. The gene nodes illustrated in FIG. 7 are gene nodes expanded from the gene node “vitamin k1 epoxide reductase” among the gene nodes primarily expanded from the seed gene nodes.

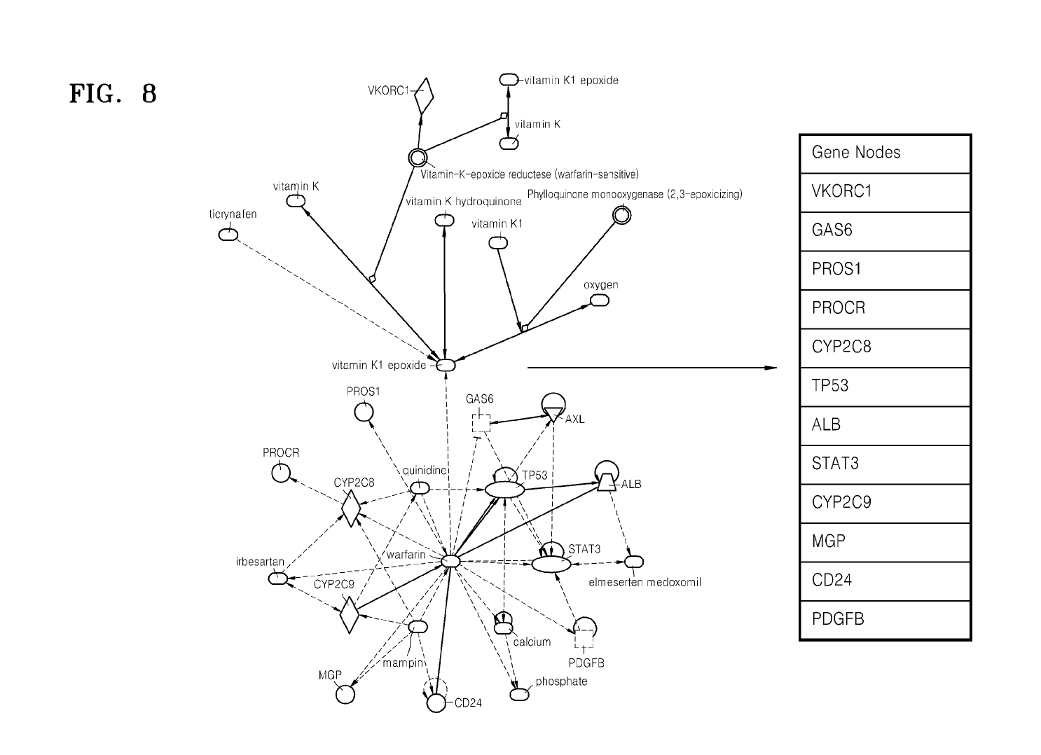

Referring again to FIG. 4, in operation 44, the data expanding unit 331 extracts only gene nodes indicating genes associated with the drug from among the gene nodes expanded in operation 43. FIG. 8 illustrates the gene nodes extracted by the data expanding unit 331 of the apparatus 3 of FIG. 1. In the present embodiment, each of the gene nodes indicates a gene, a protein, or another substance. However, for operation 44, the data expanding unit 331 only extracts the gene nodes indicating genes, associated with the drug, from among the gene nodes.

In operation 45, the data expanding unit 331 collects genetic marker information of genetic markers of the genes corresponding to the gene nodes, which are extracted in operation 44, with reference to the third database 323 stored in the storage unit 32. The third database 323 is a database recording and storing information about genetic markers of various genes. A genetic marker is a gene or a DNA sequence with a particular location on a chromosome, and can be described as a variation. A representative example of a genetic marker may be a single nucleotide polymorphism (SNP). The SNP is one or tens of base variations among 3 billion base sequences of a chromosome in a cell nucleus from different individuals. Other examples of genetic markers may include a copy number variation (CNV), a sequence tagged site (STS), a short tandem repeat (STR), and a long terminal repeat (LTR). The present embodiment is not limited thereto, and it is to be understood by one of ordinary skill in the art that genetic markers other than the examples may be used.

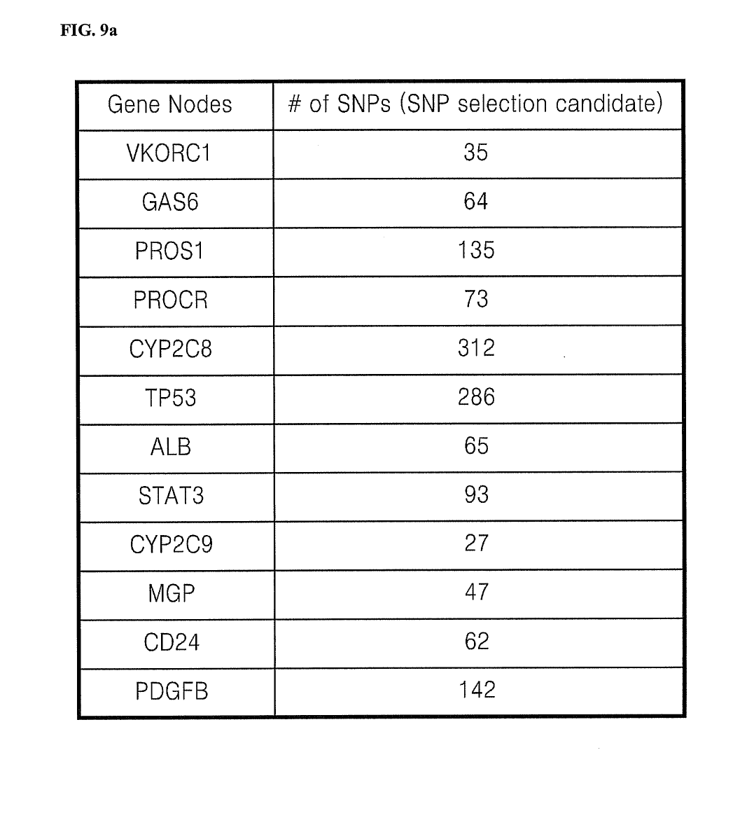

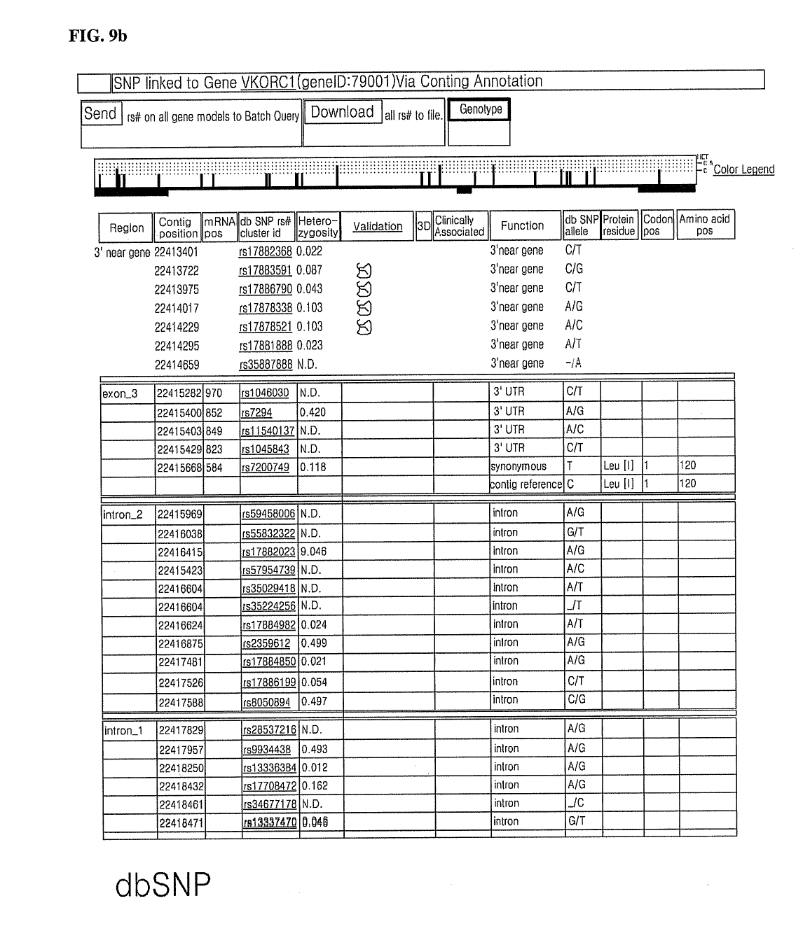

FIG. 9 shows the genetic marker information collected by the data expanding unit 331 of the apparatus 3 of FIG. 1. Referring to FIG. 9, the panel on the left demonstrates the number of SNPs associated with the genes identified in operation 44. For example, the panel on the left demonstrates that the data expanding unit 331 identified 35 SNPs associated with the VKORC1 gene, and 24 SNPs associated with the GAS6 gene.

Referring to still to FIG. 9, a SNP is used as a genetic marker of gene “VKORC1.” The number of SNPs of the gene “VKORC1” is 35, and information of each of the 35 SNPs is shown in FIG. 9 (see right table). The genetic marker information includes information about the position of a genetic marker in a base sequence. Another example of the genetic marker information will be explained when explaining the use of the genetic marker information.

In operation 23, the calculating unit 332 calculates evaluation indexes for evaluating the degree of association between the drug and the genetic markers of the genes corresponding to the gene nodes. In the present embodiment, the evaluation indexes include a coverage, which is a probability that the genetic markers could cover all variations of the genes associated with the drug, and a statistical power, which is a probability that the genetic markers could determine true genetic variations of the genes associated with the drug.

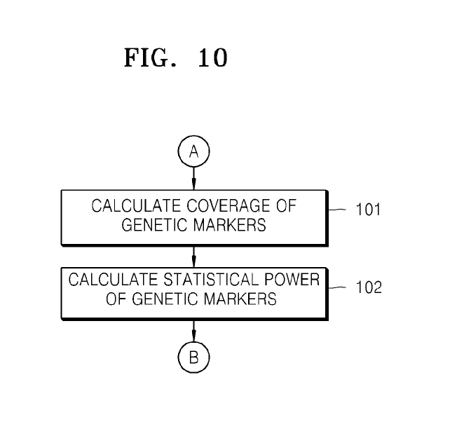

FIG. 10 is a flowchart illustrating an exemplary embodiment of operation 23 of the method of FIG. 2. Operation 23 of the method of FIG. 2 includes the operations shown in FIG. 10 sequentially processed by the calculating unit 332 of the apparatus 3 of FIG. 1. The operation of the calculating unit 332 of the apparatus 1 of FIG. 1 will now be explained in detail with reference to the flowchart of FIG. 10.

In operation 101, the calculating unit 332 calculates the coverage of the genetic markers based on the genetic marker information collected by the data expanding unit 331 in operation 45 illustrated in FIG. 4. The genetic marker information includes an allele frequency that is a measure of the relative frequency of an allele at a genetic locus in a population. In general, the coverage of the genetic markers is calculated using a relationship between the allele frequency and a common genetic variation.

In operation 102, the calculating unit 332 calculates the statistical power of the genetic markers based on the genetic marker information collected in operation 45 illustrated in FIG. 4. The genetic marker information includes a value indicating an interaction between a drug and a gene, and a value indicating the frequency of occurrences of a genetic variation. In general, the statistical power is calculated using the value indicating the interaction between the drug and the gene and the value indicating the frequency of occurrences of the genetic variation.

The coverage and the statistical power may be calculated in various well-known ways, for example, as disclosed in “Coverage and Power in Genomewide Association Studies,” written by Eric Jorgenson and John S. Witte (Jorgenson and Witte, Am. J. Hum Genet. 2006; 78:884-888); “Power to Detect Risk Alleles using Genome-wide Tag SNP Panels,” written by Michael A. Eberle, Pauline C. Ng, Kenneth Kuhn etc., (Eberle M A, Ng P C, Kuhn K, Zhou L, Peiffer D A, et al. 2007 Power to Detect Risk Alleles Using Genome-Wide Tag SNP Panels. PLoS Genet 3(10): e170.doi:10.1371/journal.pgen.0030170); and “Evaluation Coverage of Genome-wide Association Studies,” written by Jeffrey C Barrett, Lon R Cardon (Barrett and Cardon, Nature Genet 2006:38(6):659-662). A method of calculating the coverage and the statistical power is not an integral part of the one or more embodiments, and thus a detailed explanation thereof will not be given.

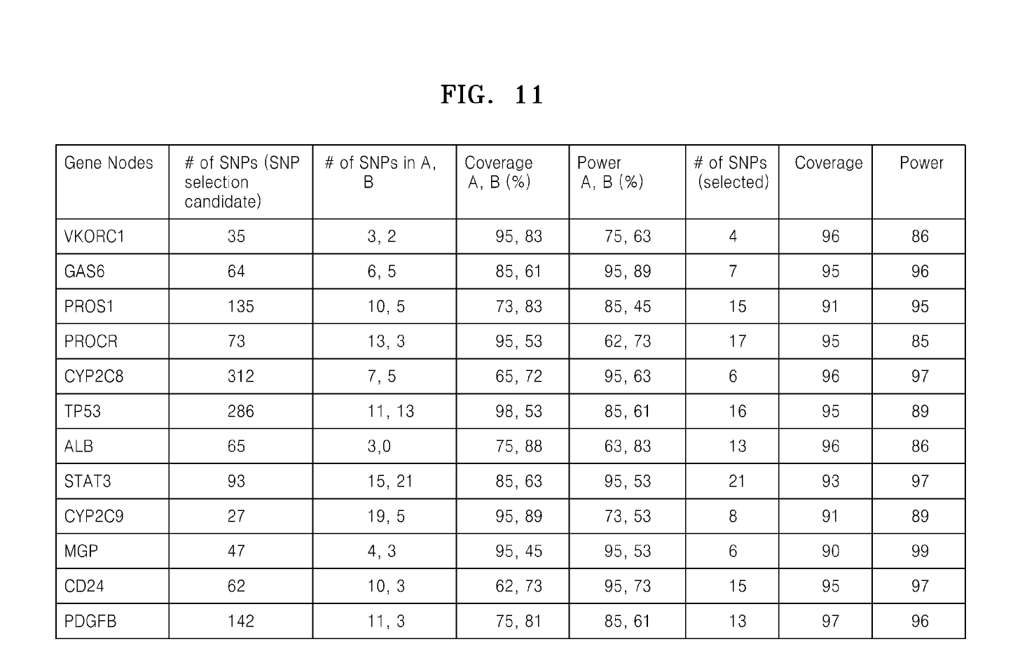

FIG. 11 shows a table including the coverage and the statistical power of the genetic markers calculated by the calculating unit 332 of the apparatus 3 of FIG. 1. Referring to FIG. 11, the number of SNPs of the gene “VKORC1” is 35, and when 4 SNPs of the 35 SNPs are selected, the coverage of the 4 SNPs is 96% and the statistical power of the 4 SNPs is 86%. If more SNPs are selected, the coverage and statistical power may be increased. However, since the number of all SNPs which may be analyzed by the genome analysis device 2 is limited due to hardware specifications of the genome analysis device 2, the number of SNPs of the gene “VKORC1” needs to be properly determined in consideration of the number of SNPs of other genes. A combination of the genetic markers whose coverage and statistical power are to be calculated in operations 101-102 illustrated in FIG. 10 is determined by the selecting unit 333, and the calculating unit 332 and the selecting unit 333 cooperate with each other in order to select optimal genetic markers.

In operation 24, the selecting unit 333 selects genetic markers of the genes corresponding to the gene nodes, which are expanded by the data expanding unit 331, based on the evaluation indexes calculated by the calculating unit 332 in operation 23. The number of genetic markers of the genes corresponding to the gene nodes selected in consideration of the number of SNPs that may be analyzed by the genome analysis device 2. In the present embodiment, the evaluation indexes include a coverage, which is a probability that the genetic markers could cover all genetic variations of the genes associated with the drug, and a statistical power, which is a probability that the genetic markers could determine true genetic variations of the genes associated with the drug.

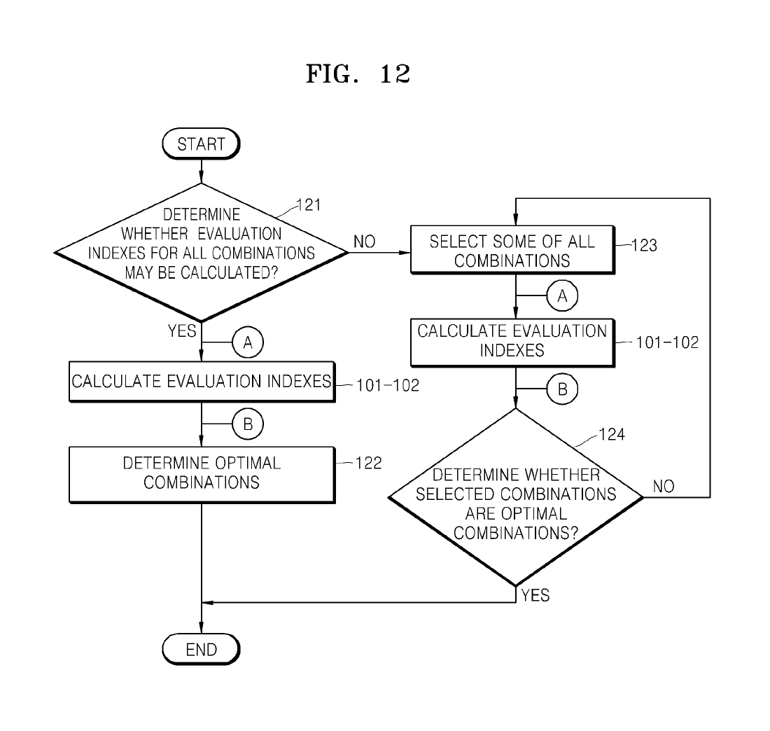

FIG. 12 is a flowchart illustrating an exemplary embodiment of operation 24 of the method of FIG. 2. The operation of the selecting unit 333 of the apparatus 3 of FIG. 1 will now be explained in detail with reference to the flowchart of FIG. 12. Referring to FIG. 12, operation 24 includes the following operations sequentially processed by the selecting unit 333 of the apparatus 3 of FIG. 1.

In operation 121, the selecting unit 333 determines whether evaluation indexes for all combinations of the genetic markers of the genes corresponding to the gene nodes extracted by the data expanding unit 331 in operation 44 may be calculated in consideration of the number of all SNPs that may be analyzed by the genome analysis device 2. If it is determined in operation 121 that the evaluation indexes may be calculated, the method proceeds to operation 101 illustrated in FIG. 10 and if it is determined in operation 121 that the evaluation indexes may not be calculated, the method proceeds to operation 123.

In operation 122, the selecting unit 333 determines optimal combinations of all the combinations of the genetic markers of the genes corresponding to the gene nodes, which are extracted by the data expanding unit 331 in operation 44, based on the coverage and the statistical power calculated by the calculating unit 332 in operations 101-102. That is, in operation 122, the selecting unit 333 determines that combinations having highest average coverage and statistical power among all the combinations of the genetic markers of the genes corresponding to the gene nodes extracted by the data expanding unit 331 in operation 44 are optimal combinations.

In operation 123, the selecting unit 333 selects combinations of the genetic markers of the genes corresponding to the gene nodes, which are extracted by the data expanding unit 331, in consideration of the number of SNPs that may be analyzed by the genome analysis device 2. The number of combinations of the genetic markers of the genes corresponding to the gene nodes selected in consideration of the number of SNPs that may be analyzed by the genome analysis device 2. Although the genetic markers may be selected most precisely when the evaluation indexes for all the combinations of the genetic markers are calculated, the amount of calculation is too large. Accordingly, when the hardware specifications of the apparatus 3 may not support such large calculation amount resulting in slow processing speed, only some of the combinations of the genetic markers are selected. In particular, in operation 123, the selecting unit 333 may select some of the combinations of the genetic markers of the genes corresponding to the gene nodes, which are extracted by the data expanding unit 331, by using an existing search technique that searches for optimal combinations from among a plurality of combinations. Examples of the search technique may include a genetic algorithm, an expectation maximization algorithm, and a simultaneous annealing algorithm. Once the combinations of the genetic markers are selected in operation 123, the method proceeds to operation 101 illustrated in FIG. 10.

In operation 124, the selecting unit 333 determines whether the combinations selected in operation 123 are optimal combinations based on the coverage and the statistical power, which are calculated by the calculating unit 332 in operations 101-102. If it is determined in operation 124 that the combinations selected in operation 123 are optimal combinations, the method ends, and otherwise, the method returns to operation 123. In the latter case, operations 123-124 are repeated until the combinations selected in operation 123 are optimal combinations. For example, if the coverage and the statistical power calculated by the calculating unit 332 in operations 101-102 exceed the coverage and the statistical power of genetic markers of corresponding genes which are already known, the selecting unit 333 determines that the combinations selected in operation 123 are optimal combinations.

Referring to FIG. 11, the number of SNPs of the gene “VKORC1” is 35. For FIG. 11, a first set, Set #1, includes 3 SNPs selected randomly from the 35 SNPs and a second set, Set #2, includes 2 SNPs selected randomly from the 35 SNPs. Referring to FIG. 11, Set #1 is referred to as “A” and Set #2 is referred to as “B.” If 3 SNPs of the 35 SNPs are selected by using SNP combinations (Set#1″), the coverage of the 3 SNP is 95% and the statistical power of the 3 SNPs is 75%. If 2 SNPs of the 35 SNPs are selected by using SNP combinations (Set#2), the coverage of the 2 SNPs is 83% and the statistical power of the 2 SNPs is 63%. If the coverage and the statistical power calculated by the calculating unit 332 in operations 101-102 exceed the coverage and the statistical power which are preset in each of Set #1 (A) and Set #2 (B), the selecting unit 333 determines in operation 124 that the combinations selected in operation 123 are optimal combinations. The present embodiment is not limited thereto, and whether the combinations selected in operation 123 are optimal combinations may be determined based on various standards. For example, the various standards may include the number of all SNPs which may be analyzed by the genome analysis device 2.

Referring to FIG. 2, in operation 25, the output unit 34 outputs genetic marker information of the genetic markers of the optimal combinations, which are selected in operation 24, directly to the user. Optionally, in operation 25, the output unit 34 outputs genetic marker information of the genetic markers of the optimal combinations, which are selected in operation 24 to the genome analysis device 2 and a server of the genome analysis device manufacturer. The genetic marker information of the genetic markers of the optimal combinations selected in operation 24 may be provided to the genome analysis device manufacturer, and the genome analysis device manufacturer manufactures the genome analysis device 2, e.g., a DNA chip, reflecting the genetic markers of the optimal combinations selected in operation 24. Further, the genetic marker information of the genetic markers of the optimal combinations selected in operation 24 may be directly input to the genome analysis device 2 to be used by the genome analysis device 2. In the present embodiment, genetic markers of optimal combinations for one drug may be selected, or genetic markers of optimal combinations for a plurality of drugs may be selected. The genetic markers of the optimal combinations for one drug may be used for personalized prescription, and the genetic markers of the optimal combinations for the plurality of drugs may be used for combination therapy of a drug group. Examples of the drug group may include drugs considered to be administered to a particular individual, drugs related to a particular disease, and pipeline drugs of a particular pharmaceutical company.

In the one or more embodiments, since the optimal combinations are selected from the combinations of the genetic markers based on the coverage and the statistical power of the genetic markers of the genes associated with the drug, the genome analysis device 2 may offer efficient and excellent performance by focusing on the drug. Furthermore, since the gene nodes indicating the genes associated with the drug are expanded, the genetic markers of the genes secondarily or otherwise associated with the drug as well as the genetic markers of the genes primarily associated with the drug target, metabolism, delivery, and toxicity of the drug are considered, and thus the genome analysis device 2 may reflect almost all genes associated with the drug. Moreover, since only the genetic markers having the coverage and the statistical power exceeding given values are selected, the performance of the genome analysis device 2 may satisfy given user standards.

As described above, according to the one or more of the above embodiments, since some of a plurality of genetic markers of genes associated with a drug are selected based on evaluation indexes of the genetic markers, a genome analysis device may offer efficient and excellent performance by focusing on the drug.

The one or more embodiments may be written as computer programs and may be implemented in general-use digital computers that execute the programs using a computer-readable recording medium. Data used in the one or more embodiments may be recorded by using various units on the computer-readable recording medium. Examples of the computer-readable recording medium include magnetic storage media, e.g., read only memories (ROMs), floppy discs, and hard discs, and optically readable media, e.g., compact disc-read only memories (CD-ROMs) and digital versatile discs (DVDs).

While exemplary embodiments have been particularly shown and described, it will be understood by those of ordinary skill in the art that various changes in form and detail may be made therein without departing from the spirit and scope of the present disclosure as defined by the following claims. The exemplary embodiments need to be considered in a descriptive sense only and not for purposes of limitation. Therefore, the scope of the present disclosure is defined not by the detailed description but by the appended claims, and all differences within the scope will be construed as being included in the present disclosure.

What is claimed is:

1. A method of selecting pharmacogenomic markers, the method comprising:
calculating evaluation indexes for evaluating the degree of association between genetic markers of genes associated with at least one drug and the drug; and
selecting genetic markers based on the calculated evaluation indexes.

2. The method of claim 1, wherein the selecting comprises selecting optimal combinations from among combinations of the genetic markers of the genes associated with the drug based on the calculated evaluation indexes.

3. The method of claim 2, wherein the selecting comprises selecting optimal combinations from among all combinations of the genetic markers of the genes associated with the drug based on the calculated evaluation indexes.

4. The method of claim 2, wherein the selecting comprises:
selecting combinations of the genetic markers of the genes associated with the drug; and
determining whether the selected combinations are optimal combinations based on the calculated evaluation indexes.

5. The method of claim 4, wherein the selecting of the combinations of the genetic markers and the determining whether the selected combinations are the optimal combinations are repeated until the selected combinations are optimal combinations.

6. The method of claim 1, further comprising expanding gene nodes indicating the genes associated with the drug,
wherein the calculating comprises calculating evaluation indexes for evaluating the degree of association between the genetic markers of the genes corresponding to the expanded gene nodes and the drug.

7. The method of claim 6, wherein each of the gene nodes indicates a gene, a protein, or other substance associated with at least one selected from the group consisting of a drug target, metabolism, delivery, and toxicity of the drug.

8. The method of claim 6, wherein the expanding of the gene nodes comprises:
generating seed gene nodes indicating seed genes biologically primarily associated with the drug; and
expanding the gene nodes indicating the genes associated with the drug from the generated seed gene nodes.

9. The method of claim 8, wherein the expanding comprises:
generating gene nodes expanded from the generated seed gene nodes; and
generating gene nodes expanded again from the expanded gene nodes.

10. The method of claim 9, wherein the expanding of the gene nodes is repeated until the number of expansions reaches a threshold.

11. The method of claim 1, wherein the evaluation indexes comprise at least one of
a coverage, which is a probability that the genetic markers could cover all genetic variations of the genes associated with the drug, and
a statistical power, which is a probability that the genetic markers could determine true genetic variations of the genes associated with the drug.

12. The method of claim 1, further comprising receiving information about the drug from a user terminal,
wherein the calculating comprises calculating evaluation indexes for evaluating the degree of association between genetic markers of genes associated with the drug and the drug.

13. A computer-readable recording medium having embodied thereon a program for executing a method of selecting pharmacogenomic markers,
wherein the method comprises:
calculating evaluation indexes for evaluating the degree of association between genetic markers of genes associated with at least one drug and the drug; and
selecting the genetic markers based on the calculated evaluation indexes.

14. An apparatus for selecting pharmacogenomic markers, the apparatus comprising:
a calculating unit calculating the degree of association between genetic markers of genes associated with at least one drug and the drug; and
a selecting unit selecting genetic markers based on the calculated evaluation indexes.

15. The method of claim 14, wherein the selecting unit selects optimal combinations from among combinations of the genetic markers of the genes associated with the drug based on the calculated evaluation indexes.

16. The method of claim 14, further comprising a data expanding unit expanding gene nodes indicating the genes associated with the drug,
wherein the calculating unit calculates evaluation indexes for evaluating the degree of association between the genetic markers of the genes corresponding to the expanded gene nodes and the drug.

17. A method for selecting pharmacogenetic markers associated with a compound, the method comprising:
selecting a compound, wherein the compound may be a drug, a gene, a protein, or other biomolecule;
obtaining information about the compound;
expanding gene nodes indicating genes biologically associated with the compound;
calculating evaluation indexes demonstrating the degree of association between the compound and genetic markers of genes associated with the compound;
selecting the genetic markers of the genes associated with the compound based on the evaluation indexes;
providing information about the selected genetic marker and optimal combinations of the genetic markers for use as pharmacogenetic markers associated with a compound to a user.

18. An apparatus for selecting pharmacogenomic markers associate with a compound, the apparatus comprising:
a communication unit;
a data storage unit;
a processing unit comprising
a selecting unit,
a calculating unit for calculating evaluation index indicating the degree of association between a compound and genetic markers of genes associated with the compound, and
a selecting unit for selecting genetic markers based on the evaluation indexes determined by the calculating unit; and
an output unit.
